(19) United States
(12) Patent Application Publication
(10) Pub. No.: US 2026/0301133 A1
(43) Pub. Date: Oct. 1, 2026

(54) GAZE AND HEAD TRACKING INFORMED HARDWARE-BASED PASSTHROUGH NOISE REDUCTION

(71) Applicant: Apple Inc., Cupertino, CA (US)

(72) Inventors: Simon Fortin-Deschenes, Santa Clara, CA (US); Joseph Cheung, San Jose, CA (US); David R. Pope, Campbell, CA (US)

(21) Appl. No.: 19/559,053

(22) Filed: Mar. 6, 2026

Related U.S. Application Data
(60) Provisional application No. 63/779,738, filed on Mar. 28, 2025.

(51) Int. Cl. G06T 5/70; G06F 3/01; G06T 3/18; G06T 5/50; G06T 7/50; G06T 19/00

(52) U.S. Cl. CPC G06T 5/70; G06F 3/012; G06F 3/013; G06T 3/18; G06T 5/50; G06T 7/50; G06T 19/006; G06T 2207/10016; G06T 2207/20182; G06T 2207/20216

(57) ABSTRACT

Various implementations disclosed herein include devices, systems, and methods that improve passthrough video image quality using a hardware-based temporal noise reduction process. For example, a process may obtain image content. The image content may include frames corresponding to views of a three-dimensional (3D) environment. The frames may include a current frame and previously-captured frames. The process may further predict a user head pose corresponding to a viewpoint of an image sensor with respect to the 3D environment. The process may further estimate depth attributes corresponding to distances of elements of a scene depicted in the current frame and generate an enhanced frame by combining the current frame with the previously-captured frames. Combining the frames may be based on aligning the previously-captured frames with the current frame based on the predicted user head pose and the estimated depth attributes. The process may further present the enhanced frame.

### CROSS-REFERENCE TO RELATED APPLICATIONS

This Application claims the benefit of U.S. Provisional Application Ser. No. 63/779,738 filed Mar. 28, 2025, which is incorporated herein in its entirety.

### TECHNICAL FIELD

The present disclosure generally relates to systems, methods, and devices that use a hardware-based temporal noise reduction process to improve passthrough video image quality for viewing via electronic devices, such as head-mounted devices (HMDs).

### BACKGROUND

Existing techniques for enabling a user to view image content on a display of a device may be improved with respect to reduction of noise caused by short exposure time and low-light environments to provide desirable viewing experiences.

### SUMMARY

Various implementations disclosed herein include devices, systems, and methods that improve passthrough image content quality by removing noise from image frames using a hardware-based temporal noise reduction process without significantly affecting live-passthrough image latency. In some implementations, noise may be removed from a current frame of image content, for example of a video, using pixel values from one or more prior frames. For example, pixel values from one or more prior frames of the Image content may be aligned with those of the current frame and then averaged (or otherwise combined) with the current frame to reduce the noise in the current frame.

In some implementations, a de-noising homography algorithm may be implemented to warp or align pixels from a prior frame(s). For example, a previous image may be warped to a current frame such that depicted image content is aligned within the frames. In some implementations, a single historical frame including an accumulation of at least some of or all of the previous frames may be used in the warping process. For example, an accumulation of at least some of or all of the previous frames may be an average of multiple frames.

In some implementations, a warping process may be implemented based on head tracking and depth estimation information.

In some implementations, a warping technique (e.g., a pyramid warper) may be used such that low frequencies are initially fused and higher frequencies are subsequently added at lower levels of the pyramid.

In some implementations, gaze information may be used to identify a user attention point to improve image quality in image areas associated with user attention. For example, a warp mesh may be used to provide a highest image quality in areas associated with a determined user gaze.

In some implementations, an electronic device has a processor (e.g., one or more processors) and one or more displays that execute instructions stored in a non-transitory computer-readable medium to perform a method. The method performs one or more steps or processes. In some implementations, the electronic device obtains image content from an image sensor. The image content comprises frames corresponding to views of a three-dimensional (3D) environment. The frames may include a current frame and one or more previously-captured frames. In some implementations, a user head pose may be predicted based on sensor data obtained via one or more sensors. The user head pose may correspond to a viewpoint of the image sensor with respect to the 3D environment during capture of the current frame. In some implementations, depth attributes corresponding to distances of one or more elements of a scene depicted in the current frame may be estimated. In some implementations, an enhanced frame may be generated by combining the current frame with the one or more previously-captured frames. The combining may be based on aligning at least one of the previously-captured frames with the current frame based on any combination of the predicted user head pose, predicted user eye tracking, and the estimated depth attributes. In some implementations, the enhanced frame may be presented to the user via the one or more displays.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment in accordance with some implementations.

FIG. 2 illustrates a block diagram of a hardware (HW) based temporal noise reduction pipeline that leverages multiple frames of video to distinguish random noise from actual scene details, in accordance with some implementations.

FIG. 3 illustrates a pipeline configured to enable a similarity feature calculation between a current frame and a previous frame(s), in accordance with some implementations.

FIG. 4 illustrates images of a person, in accordance with some implementations.

FIG. 5 is a flowchart representation of an exemplary method that improves passthrough video image quality by denoising video frames using a hardware-based temporal noise reduction process with no added latency, in accordance with some implementations.

FIG. 6 is a block diagram of an electronic device, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

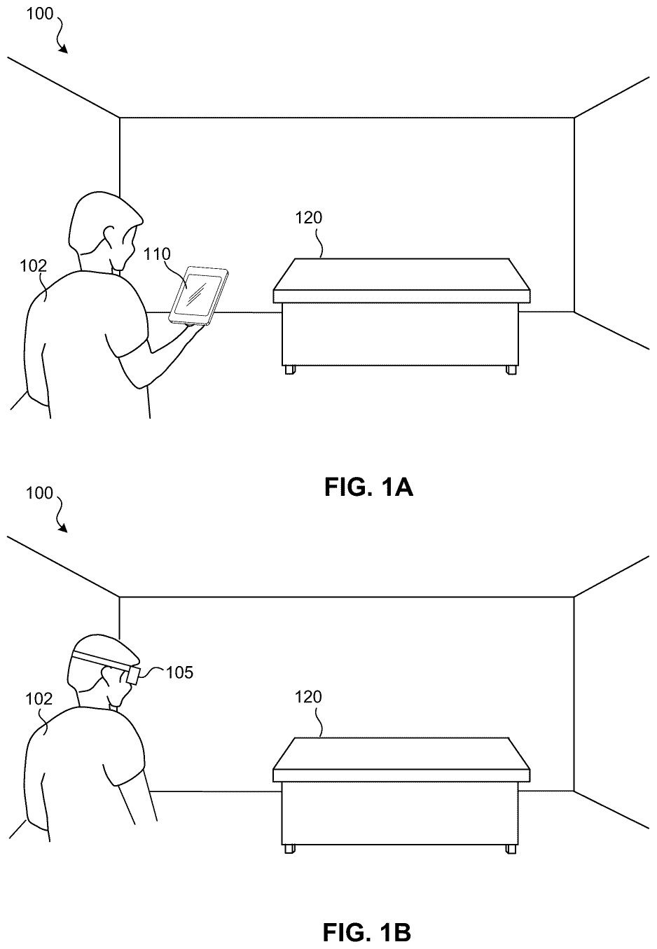

FIGS. 1A-B illustrate exemplary electronic devices 105 and 110 operating in a physical environment 100. In the example of FIGS. 1A-B, the physical environment 100 is a room that includes a desk 120. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user 102 within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that are generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, an electronic device (e.g., device 105 such as an HMD) may be configured to implement a hardware-based temporal noise reduction process to improve passthrough video image quality without adding latency.

In some implementations, image content such as a video frame(s) or image(s) may be obtained from an image sensor. The image content may include video frame(s) or image(s) that correspond to views of a three-dimensional (3D) environment. For example, video frames of a physical environment or an XR environment may be obtained based on a video stream captured by an image sensor over time. In some implementations, the video frame(s) or image(s) may include a current frame and previously-captured frames.

In some implementations, a head pose of a user may be predicted based on sensor data obtained via sensors such as, for example, inertial measurement (IMU) sensors, optical tracking sensors, infrared sensors, time of flight sensors, ultrasound sensors, etc. In some implementations, the head pose of the user may correspond to a viewpoint of an image sensor with respect to a 3D environment during capture of a current frame. In some implementations, predicting a head pose of a user may include tracking a user head pose and viewpoint changes over time from frame to frame. Accordingly, a change in the user head pose and viewpoint for the current frame may be predicted prior to sensor data being available for the current frame.

In some implementations, depth attributes corresponding to distances of elements of the scene depicted in the current frame may be estimated.

In some implementations, an enhanced frame comprising less noise may be generated by combining a current frame with the previously-captured frames. Combining a current frame with the previously-captured frames may be based on aligning at least one of the previously-captured frames with the current frame based on a predicted user head pose and estimated depth attributes.

In some implementations, the enhanced frame may be presented to user via one or more displays of an electronic device such as an HMD.

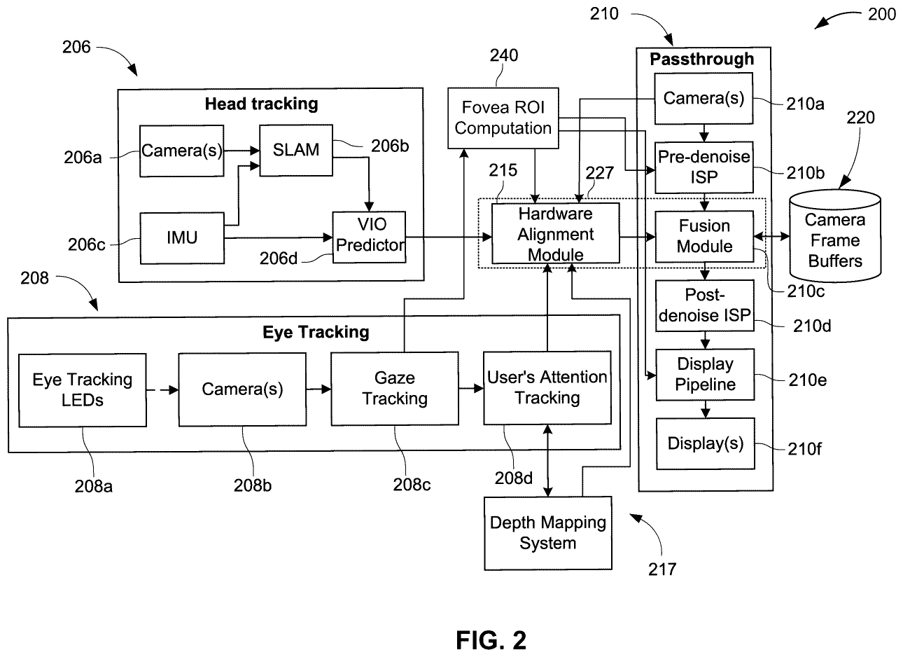

FIG. 2 illustrates a block diagram of a HW based temporal noise reduction pipeline 200 that leverages multiple frames of video to distinguish random noise from actual scene details, in accordance with some implementations.

In some implementations, temporal noise reduction pipeline 200 may be configured to enable a hardware-based noise reduction process to improve live passthrough video quality without introducing latency by leveraging: a temporal noise reduction process, homography-based alignment, pyramid (or any type of) warping, and gaze tracking.

In some implementations, a temporal noise reduction process may be configured to combine information from a current frame and prior frames (of pass-through video) via temporal averaging. For example, noise in a frame (of video) may be reduced by averaging pixel values from the current frame and one or more prior frames. In some implementations, a history frame may be maintained and combined with a current frame to reduce noise. A history frame may include accumulated averaged data from multiple past frames that have been weighted to emphasize recent frames. In some implementations, registration of the history frame may include options for adapting to a changing fovea region of interest (ROI) location. For example, image signal processing (ISP) based foveation may be performed (e.g., via a fovea ROI computation module 240 of the pipeline 200) to generate a high-resolution image of a portion of a camera capture (e.g., corresponding to the fovea ROI location) and a low-resolution full-view image (e.g., corresponding to most or all of the field of view (FOV) captured by the camera). These two images are processed by an ISP pipeline and then composited (e.g., via a GPU) for a device's display to provide a view. In some implementations, this fovea ROI location may change based on, for example, changing or moving user gaze. Accordingly, a history frame may include options for adapting to this change.

In some implementations, blending of post-ISP fovea and periphery images may include logic to mitigate increased noise in fovea disocclusion areas caused by moving gaze. Noise mitigation may be performed by compensating for resolution and noise and by prioritizing sampling from a periphery image at an edge of a fovea region.

In some implementations, a homography-based warping/alignment process may be configured to align prior frames with a current frame using head tracking and depth estimation data. For example, to accurately combine pixels from different frames, homography-based alignment may be performed using head tracking data to provide global motion estimates to warp previous frames to a current frame. Likewise, depth estimation data may be used to account for scene depth variations thereby ensuring proper alignment of objects at different distances. In some implementations, a warping algorithm may be enabled to align prior frames by transforming associated pixels to match a spatial geometry of a current frame thereby ensuring that pixels from prior frames represent same real-world scene content prior to averaging pixel values.

In some implementations, pyramid warping may be used to perform noise reduction within a multi-scale framework by initially emphasizing low frequencies. For example, a noise reduction process may be configured to operate with respect to a pyramid representation of video frames.

In some implementations, gaze tracking may be used to prioritize noise reduction with respect to user attention areas for better perceptual quality. For example, gaze tracking may be used to prioritize an area where a user is looking to produce a higher precision mesh within the gazed-upon region for better alignment and noise suppression. Likewise, areas outside a user's focus may be processed with lower precision to, for example, save computational resources.

In some implementations, pipeline 200 includes a headtracking system 206, an eye tracking system 208, a pass-through image system 210, a depth mapping system 217, fovea ROI computation module, and a fusion pipeline 227.

In some implementations, headtracking system 206 includes a simultaneous localization and mapping (SLAM) pipeline 206a and a visual-inertial odometry (VIO) predictor module 206d that incorporates high-frequency IMU data (obtained from IMU sensors 206c such as, for example, an accelerometer, a gyroscope, etc.) and low-frequency camera images (obtained from cameras 206a) to enable a (user) headtracking process. The headtracking process is configured to predict and align head poses across video frames to accurately align a warp mesh and account for rotation and translation. For example, VIO predictor module 206d leverages IMU data to predict a head pose at a precise moment when a camera frame will be captured by, for example, a camera(s) 210a of pass-through image system 210.

In some implementations, depth mapping system 217 is configured to use stereo cameras or a monocular depth estimation model to generate depth maps to be combined with a predicted head pose(s) to enable a fusion pipeline 227 (including a hardware alignment module 215 and a hardware fusion module 210c) to construct a warp mesh comprising pixel-to-pixel transformations between frames to compensate for pose changes (e.g., orientation and translation) between frames and enable an accurate warping process to warp a previous frame to a current or predicted frame. In some implementations, depth mapping system 217 may be enabled to provide depth information by using a depth estimation model (monocular or stereo) to compute a depth map for each frame of video.

In some implementations, fusion pipeline 227 is configured to construct a hardware-compatible warp mesh for a previous frame to a current or predicted frame alignment by integrating depth estimation (from depth mapping system 217), pose differences (between a previous frame and a current or predicted frame), and a hardware based fusion process to align the video frames. For example, fusion pipeline 227 may include a hardware block (e.g., hardware alignment module 215 and/or hardware fusion module 210c) designed for patch-based temporal noise reduction processes that compare patches from a history frame and a current frame to enable decisions about individual pixels or an entire patch thereby balancing computational efficiency with high-quality noise reduction within passthrough video system 210. In some implementations, the history frame may be registered with respect to options for adapting to a changing fovea region of interest (ROI) location via fovea ROI computation module as described, supra.

In some implementations, a hardware-compatible warp mesh may be constructed by using hardware alignment module 215 to convert pixel correspondence into a mesh structure and optimize the mesh structure for hardware processing. Subsequently, the generated mesh may be sent to a hardware block (e.g., fusion module 210c) to process the mesh to align a previous frame with a new frame to minimize artifacts caused by motion or depth discrepancies.

In some implementations, optional eye tracking system 208 is configured to provide input for fusion pipeline 227 to further enhance a warping process. Eye tracking system 208 may include eye tracking LEDs 208a, eye tracking cameras 208b, gaze tracking logic 208c, and user attention tracking logic 208d to implement an eye tracking process.

In some implementations, input information provided by eye tracking system 208 may be used to increase an accuracy of alignment between a historical frame(s) and a new frame by utilizing eye movement to provide additional cues that refine a prediction of where a user gaze is focused, thereby allowing for more precise alignment of images and improved compensation for head motion. For example, a predicted gaze area may be used to anticipate a region of an image requiring alignment in a warp process, even if the user's head is moving. Accordingly, a process for integrating an eye position with head pose and depth data enables an improved estimate a 3D position of the user's gaze in the real world thereby allowing a precise calculation of a transformation used for an image warp.

In some implementations, passthrough system 210 includes a camera(s) 210a for current frame capture, a pre-noise image signal processor (ISP) 210b for initial frame processing, fusion module 210c to construct a warp mesh, a post de-noise ISP 210d for post warp processing, and a display pipeline 210e and a display(s) 210f for rendering and display of a warped image with reduced or no noise. Likewise, passthrough system 210 may include a camera frame buffer 220 for accumulating pixel values and tracking confidence scores for pyramid levels to adaptively adjust a noise model based on a degree of averaging. For example, camera frame buffer 220 may be configured to store a history of all previous frames at each pixel location in a pyramid.

In some implementations, a hardware-compatible warp mesh may optionally include hardware support for local spatial resolution improvements such as quad-tree encoding around, for example, depth discontinuity areas and around a user point of attention. In some implementations, depth mapping system 217 may be additionally queried providing more accurate depth surrounding the user point of attention.

In some implementations, the hardware-compatible warp mesh may optionally compensate for moving objects via motion vector estimation from previous frames.

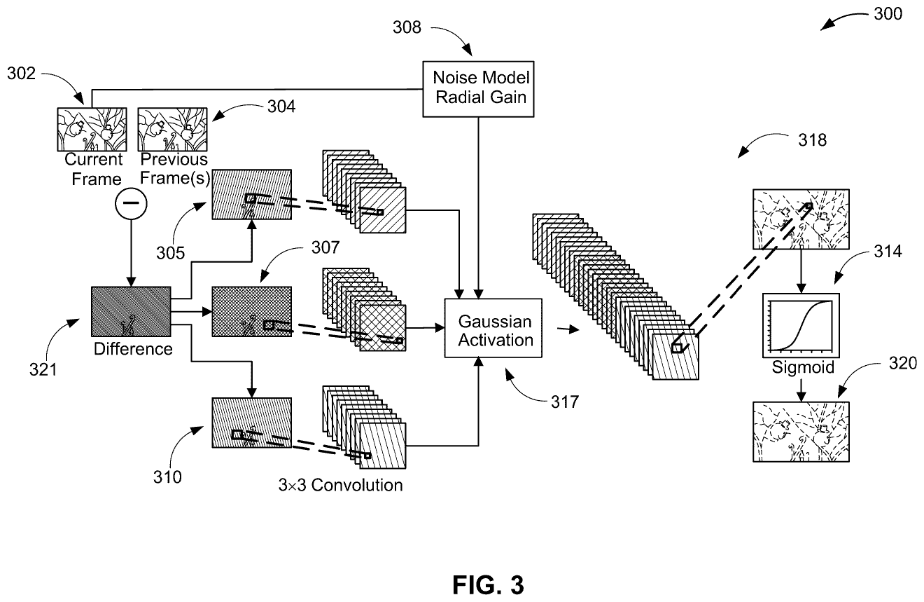

FIG. 3 illustrates a pipeline 300 configured to enable a similarity feature calculation between a current frame 302 and a previous frame(s) 304, in accordance with some implementations. In some implementations, multi-scale features of frames 302 and 304 (e.g., a current and previous frame(s)) are extracted using 3×3 convolutions to determine a difference 321 and compute/extract local similarity features 305, 307 and 310 between frames 302 and 304. For example, 3×3 filters may be applied to extract fine-grained similarity between frames 302 and 304 and capture motion & texture differences at a pixel level.

In some implementations, a noise model 308 incorporating radial gain correction may be applied to account for vignetting and sensor noise and to enhance edge pixels having a low brightness.

In some implementations, gaussian activation 317 may be used to emphasize smooth transitions (and suppress noise) in similarity estimation and generate global similarity features 318.

In some implementations, sigmoid activation 314 may be used for similarity map calculations to normalize similarity values while maintaining smooth gradients to ensure a continuous and differentiable transition between frames during fusing similarity-based warping using a pyramid approach. Subsequently, a multi-scale similarity map 320 may be generated to guide frame reconstruction and reduce artifacts and noise from incorrect homography alignments.

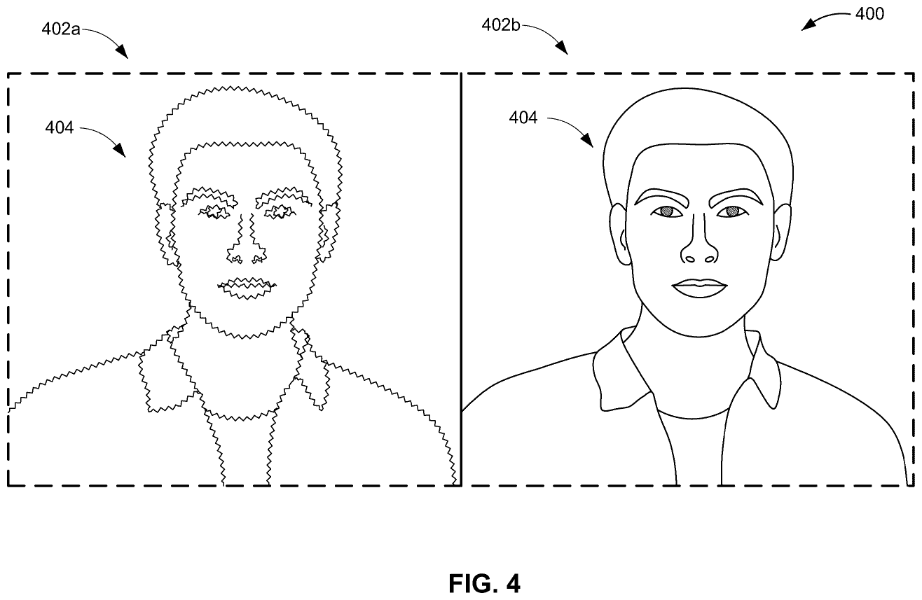

FIG. 4 illustrates images 402a and 402b of a person 404, in accordance with some implementations. Image 402a represents an image of person 404 comprising noise and therefore does not provide a clear and optimal view of person 404. For example, the view of person 404 in image 402a may appear to be blurry or out of focus. Image 402b represents an image of person 404 processed by the HW based temporal noise reduction pipeline 200 of FIG. 2 that distinguishes random noise from actual scene details.

In some implementations, temporal noise reduction pipeline 200 of FIG. 2 is configured to enable a hardware-based noise reduction process to improve live passthrough video quality such as, for example, constructing image 402b of person 404.

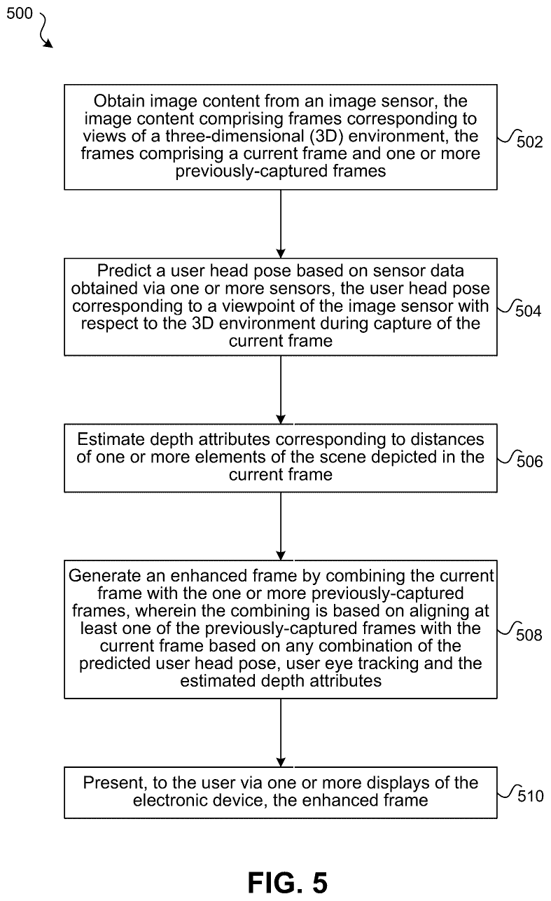

FIG. 5 is a flowchart representation of an exemplary method 500 that improves passthrough video image quality by denoising video frames using a hardware-based temporal noise reduction process with no added latency, in accordance with some implementations. In some implementations, the method 500 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 500 is performed by processing logic, including hardware, firmware, software, or a combination thereof. In some implementations, the method 500 is performed by a processor executing code stored in a non-transitory computer-readable medium (e.g., a memory). Each of the blocks in the method 500 may be enabled and executed in any order.

At block 502, the method 500 obtains image content (e.g., a video frame) from an image sensor. The image content may include frames corresponding to views of a 3D environment. In some implementations, the frames may include a current frame and one or more previously-captured frames. For example, a current frame 402 and a previous frame(s) 404 may be obtained as described with respect to FIG. 4.

In some implementations the one or more prior frames may include only a single prior frame.

In some implementations the one or more prior frames may include an accumulation of a set of frames selected from the one or more prior frames.

In some implementations, the image content may include passthrough video content.

At block 504, the method 500 predicts a user head pose based on sensor data obtained via one or more sensors. The user head pose may correspond to a viewpoint of the image sensor with respect to the 3D environment during capture of the current frame. For example, a headtracking system 206 may obtain IMU data from IMU sensors 206c (e.g., an accelerometer, a gyroscope, etc.) and camera images from cameras 206a to enable a user headtracking process as described with respect to figure

In some implementations, predicting the user head pose may include tracking changes to the viewpoint over time with respect to the frames; and predicting a change in the viewpoint with respect to the current frame prior to the sensor data being available for the current frame.

At block 506, the method 500 estimates depth attributes corresponding to distances of one or more elements of the scene depicted in the current frame. For example, a depth mapping system 217 may be configured to use stereo cameras or a monocular depth estimation model to generate depth maps for each frame of video as described with respect to FIG. 2.

At block 508, the method generates an enhanced frame (e.g., with less noise) by combining (e.g., averaging) the current frame with the one or more previously-captured frames. Combining the current frame with the one or more previously-captured frames may be based on aligning at least one of the previously-captured frames with the current frame based on any combination of the predicted user head pose, predicted user eye tracking, and the estimated depth attributes. For example, a fusion pipeline 227 may be configured to construct a hardware-compatible warp mesh for a previous frame to a current or predicted frame alignment by integrating depth estimation (from depth mapping system 217), pose differences (between a previous frame and a current or predicted frame), and a hardware based fusion process to align the video frames as described with respect to FIG. 2.

In some implementations, the hardware-compatible warp mesh may optionally include hardware support for local spatial resolution improvements such as quad-tree encoding around, for example, depth discontinuity areas and around a user point of attention. In some implementations, depth mapping system 217 may be additionally queried providing more accurate depth surrounding the user point of attention.

In some implementations, the hardware-compatible warp mesh may optionally compensate for moving objects via motion vector estimation from previous frames.

In some implementations, based on the aligning, noise may be removed from the current frame by averaging pixel values from the one or more prior frames with pixel values of the current frame.

In some implementations, removing the noise may performed based on a patch-based temporal noise reduction processes that compare patches from the one or more prior frames and the current frame to enable decisions about individual pixels or an entire patch as described with respect to FIG. 2.

In some implementations, user eye tracking or user gaze direction may be predicted (by an eye tracking system 208 as described in FIG. 2) based on the sensor data and a user attention point with respect to the image content may be identified to enable alignment of the current frame with the one or more previously-captured frames.

At block 510, the method 500 presents to the user via the one or more displays, the enhanced frame. For example, a final output image may be reconstructed using pyramid up sampling and blending.

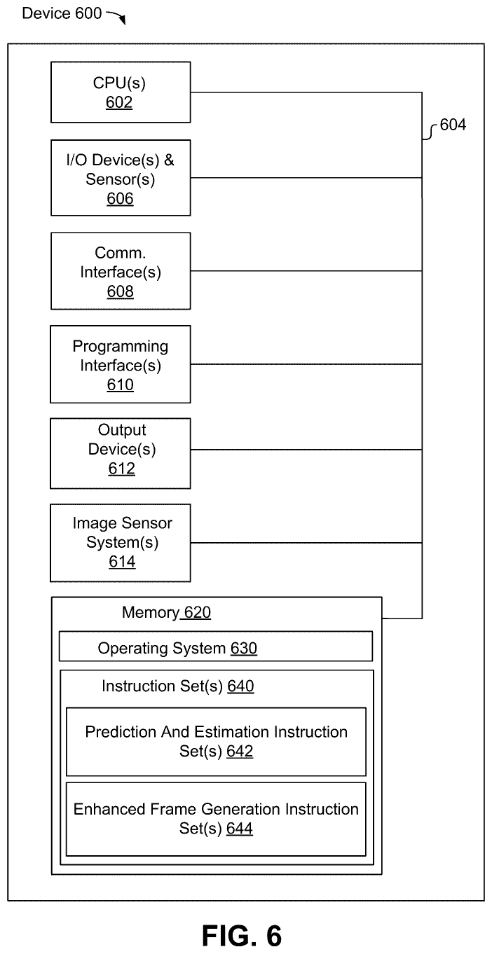

FIG. 6 is a block diagram of an example device 600. Device 600 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 600 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 610, output devices (e.g., one or more displays) 612, one or more interior and/or exterior facing image sensor systems 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 612 are configured to present a view of a physical environment, a graphical environment, an extended reality environment, etc. to the user. In some implementations, the one or more displays 612 are configured to present content (determined based on a determined user/object location of the user within the physical environment) to the user. In some implementations, the one or more displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 612 correspond to diffractive, reflective, polarized, holographic, etc. waveguide displays. In one example, the device 600 includes a single display. In another example, the device 600 includes a display for each eye of the user.

In some implementations, the one or more image sensor systems 614 are configured to obtain image data that corresponds to at least a portion of the physical environment 100. For example, the one or more image sensor systems 614 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 614 further include illumination sources that emit light, such as a flash. In various implementations, the one or more image sensor systems 614 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 600 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 600 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 600.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 includes a non-transitory computer readable storage medium.

In some implementations, the memory 620 or the non-transitory computer readable storage medium of the memory 620 stores an optional operating system 630 and one or more instruction set(s) 640. The operating system 630 includes procedures for handling various basic system services and for performing hardware dependent tasks. In some implementations, the instruction set(s) 640 include executable software defined by binary information stored in the form of electrical charge. In some implementations, the instruction set(s) 640 are software that is executable by the one or more processing units 602 to carry out one or more of the techniques described herein.

The instruction set(s) 640 includes a prediction and estimation instruction set 642 and an enhanced frame generation instruction set 644. The instruction set(s) 640 may be embodied as a single software executable or multiple software executables.

The prediction and estimation instruction set 642 is configured with instructions executable by a processor to predict a user head pose corresponding to a viewpoint of an image sensor with respect to a 3D environment during capture of a current frame and estimate depth attributes corresponding to distances of one or more elements of a scene depicted in the current frame.

The enhanced frame generation instruction set 644 is configured with instructions executable by a processor to generate an enhanced frame by combining the current frame with the one or more previously-captured frames based on the predicted user head pose and the estimated depth attributes.

Although the instruction set(s) 640 are shown as residing on a single device, it should be understood that in other implementations, any combination of the elements may be located in separate computing devices. Moreover, FIG. 6 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor and one or more displays:
obtaining image content from an image sensor, the image content comprising frames corresponding to views of a three-dimensional (3D) environment, the frames comprising a current frame and one or more previously-captured frames;
predicting a user head pose based on sensor data obtained via one or more sensors, the user head pose corresponding to a viewpoint of the image sensor with respect to the 3D environment during capture of the current frame;
estimating depth attributes corresponding to distances of one or more elements of a scene depicted in the current frame;
generating an enhanced frame by combining the current frame with the one or more previously-captured frames, wherein the combining is based on aligning at least one of the previously-captured frames with the current frame based on the predicted user head pose and the estimated depth attributes; and
presenting, to the user via the one or more displays, the enhanced frame.

2. The method of claim 1, further comprising:
predicting user gaze direction based on the sensor data; and
identifying a user attention point with respect to the image content, the combining further based on the user gaze direction.

3. The method of claim 1, further comprising:
based on the aligning, removing noise from the current frame by averaging pixel values from the one or more prior frames with pixel values of the current frame.

4. The method of claim 3, wherein removing the noise is performed based on a patch-based temporal noise reduction processes that compare patches from the one or more prior frames and the current frame to enable decisions about individual pixels or an entire patch.

5. The method of claim 1, wherein the one or more prior frames comprises only a single prior frame.

6. The method of claim 1, wherein the one or more prior frames comprises an accumulation of a set of frames selected from the one or more prior frames.

7. The method of claim 1, wherein generating the enhanced frame comprises constructing a hardware-compatible warp mesh to compensate for moving objects via motion vector estimation from the one or more previously-captured frames.

8. The method of claim 1, wherein predicting the user head pose comprises:
tracking changes to the viewpoint over time with respect to the frames; and
predicting a change in the viewpoint with respect to the current frame prior to the sensor data being available for the current frame.

9. The method of claim 1, wherein the image content comprises passthrough video content.

10. The method of claim 1, wherein combining the current frame with the one or more previously-captured frames comprises performing a pixel averaging process of the current frame with respect to the one or more previously-captured frames.

11. The method of claim 1, wherein generating the enhanced frame comprises constructing a hardware-compatible warp mesh to perform said aligning.

12. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
obtaining image content from an image sensor, the image content comprising frames corresponding to views of a three-dimensional (3D) environment, the frames comprising a current frame and one or more previously-captured frames;
predicting a user head pose based on sensor data obtained via one or more sensors, the user head pose corresponding to a viewpoint of the image sensor with respect to the 3D environment during capture of the current frame;
estimating depth attributes corresponding to distances of one or more elements of a scene depicted in the current frame;
generating an enhanced frame by combining the current frame with the one or more previously-captured frames, wherein the combining is based on aligning at least one of the previously-captured frames with the current frame based on the predicted user head pose and the estimated depth attributes; and
presenting, to the user via one or more displays of the electronic device, the enhanced frame.

13. The electronic device of claim 12, wherein the program instructions, when executed on the one or more processors, further cause the electronic device to perform operations comprising:
predicting user gaze direction based on the sensor data; and
identifying a user attention point with respect to the image content, the combining further based on the user gaze direction.

14. The electronic device of claim 12, wherein the program instructions, when executed on the one or more processors, further cause the electronic device to perform operations comprising:
based on the aligning, removing noise from the current frame by averaging pixel values from the one or more prior frames with pixel values of the current frame.

15. The electronic device of claim 14, wherein removing the noise is performed based on a patch-based temporal noise reduction processes that compare patches from the one or more prior frames and the current frame to enable decisions about individual pixels or an entire patch.

16. The electronic device of claim 12, wherein generating the enhanced frame comprises constructing a hardware-compatible warp mesh to compensate for moving objects via motion vector estimation from the one or more previously-captured frames.

17. The electronic device of claim 12, wherein predicting the user head pose comprises:
tracking changes to the viewpoint over with respect to the frames; and
predicting a change in the viewpoint with respect to the current frame prior to the sensor data being available for the current frame.

18. The electronic device of claim 12, wherein combining the current frame with the one or more previously-captured frames comprises performing a pixel averaging process of the current frame with respect to the one or more previously-captured frames.

19. The electronic device of claim 12, wherein generating the enhanced frame comprises constructing a hardware-compatible warp mesh to perform said aligning.

20. A non-transitory computer-readable storage medium storing program instructions executable via one or more processors, of an electronic device, to perform operations comprising:
obtaining image content from an image sensor, the image content comprising frames corresponding to views of a three-dimensional (3D) environment, the frames comprising a current frame and one or more previously-captured frames;
predicting a user head pose based on sensor data obtained via one or more sensors, the user head pose corresponding to a viewpoint of the image sensor with respect to the 3D environment during capture of the current frame;
estimating depth attributes corresponding to distances of one or more elements of a scene depicted in the current frame;
generating an enhanced frame by combining the current frame with the one or more previously-captured frames, wherein the combining is based on aligning at least one of the previously-captured frames with the current frame based on the predicted user head pose and the estimated depth attributes; and
presenting, to the user via one or more displays of the electronic device, the enhanced frame.
